(19) United States
(12) Patent Application Publication
(10) Pub. No.: US 2013/0153734 A1
(43) Pub. Date: Jun. 20, 2013

(54) Weight assembly for covers

(71) Applicant: Joshua Ryan Lamano, Layton, UT (US)

(72) Inventor: Joshua Ryan Lamano, Layton, UT (US)

(21) Appl. No.: 13/326,599

(22) Filed: Dec. 15, 2011

(51) Int. Cl. B32B 43/00

(52) U.S. Cl. 248/364

(57) ABSTRACT

A weight assembly that attaches to a cover; that, when used with a plurality of weight assemblies of the same type spread evenly around the edges of a cover will hold the cover in position.

### TECHNICAL FIELD AND BACKGROUND

This application relates to tools and methods for securing covers such as; tarps, equipment covers, car and boat covers, nursery ground covers and the like.

Covers are often draped over objects located outdoors to protect the objects from U.V. light, wind, rain and snow. Ropes, elastic straps, tie downs and different weight assemblies have been used to secure these covers. These current tools and methods have many drawbacks and limitations.

Ropes tangle and are time consuming to apply to a cover. Elastic straps are limited in their length and produce a recoil hazard to the user. Tie downs are bulky, expensive and, because of their ratcheting mechanism, make it easy for the user to overstress and tear the cover. Sometimes there is nothing to attach the rope, elastic strap or tie down to for securing the cover over the object. These methods can also create a tripping hazard.

Objects with mass such as a log or bricks, have been used to secure covers by setting the object on top of the cover, using gravity and friction to prevent movement of the cover. These objects are inefficient in that they do not attach to the cover and may not stay in a desired position allowing movement of the cover to occur. A weight placed on top of a cover allows wind to get under and disturb the cover. These types of objects are not always readily available.

What is needed is a weight assembly that can attach to a cover and will hold the cover in place without having to attach to anything besides the cover. Different weight assemblies have been tried but fail to produce the results necessary for this task.

One assembly is an elongated refillable tube with hooks and snaps which attach to the edge of a cover designed to span the length or width of the cover. Reference U.S. Pat. No. 7,871,052 January 2011 Baum. This assembly is awkward for use because the opening for filling the tube is only 1½″ that restricts use to a fluid, like water because sand or other weighted material will be hard for a user to insert or empty. If a liquid is used for weighted material, use may be limited to temperatures above freezing to prevent damage to the weight assembly from expanding frozen liquids. The tube weighs approximately 8 lbs. for every 2 feet of length making it difficult for a single person to lift and attach the assembly to an elevated cover. If the cover is sloping, weight in the tube will shift to the low point creating an uneven distribution of mass and uneven pressure on the cover. The components of this design make it expensive to produce, decreasing the marketability of the assembly.

Another assembly is a water-permeable weight bag designed primarily for use with a beach towel. Reference U.S. Pat. No. 5,520,364 May 1996 Bloxson. The snap used in this assembly is too weak to hold any significant weight while suspended on a cover. Being of water permeable construction, transportation of the bag may be undesirable because the bag takes time to dry completely. The referenced capacity of these assemblies, 6 to 8 oz. is too little mass to secure a cover in any significant wind. A grommet is used as part of this assembly which increases manufacturing costs and decreases durability. When a grommet is constantly submitted to pressure, such as that from a weighted object it is more likely to loose its bond on the fabric it is attached to. When this bond ceases to exist the assembly looses its contents and is not functional.

### SUMMARY

The above stated problems and other problems that may become apparent are solved by using the claimed weight assembly.

The claimed weight assembly eliminates the limitations and hazards of ropes, bungees and tie downs. It provides a way to attach an object with mass to a cover and more effectively secure the cover.

In relation to the prior art, U.S. Pat. No. 7,871,052 January 2011 Baum, the claimed weight assembly is simple for a single person to operate and use. It reduces the risk of injury from lifting one heavy object at a time by allowing the user to lift multiple objects of lesser mass multiple times. By dividing one container into multiple smaller containers the weight of the objects is more evenly distributed around the cover if the cover is on an uneven surface. One embodiment of this weight assembly has an opening of predetermined size that allows easier ingress and regress of weighted matter which increases the operability of the weight assembly for the user. The elements of this embodiment significantly reduce production costs compared to the prior art increasing the marketability of the weight assembly.

In relation to prior art, U.S. Pat. No. 5,520,364 May 1996 Bloxson, and other prior art, the grommet is eliminated and replaced with an alternate assembly for a way to attach the weighted object to the cover. One embodiment allows the weight assembly to be refillable. This provides unobvious advantages; when transporting the weight assembly empty it takes up less space in a vehicle. An empty container weighs less, thus, is easier for a person to carry from point to point when not using the weight. An empty container reduces shipping costs making the weight assembly more marketable. A refillable container allows the user to choose what weighted matter they will use to fill the container. Heavier matter makes the weight more effective in stronger winds or on larger covers.

### DESCRIPTION

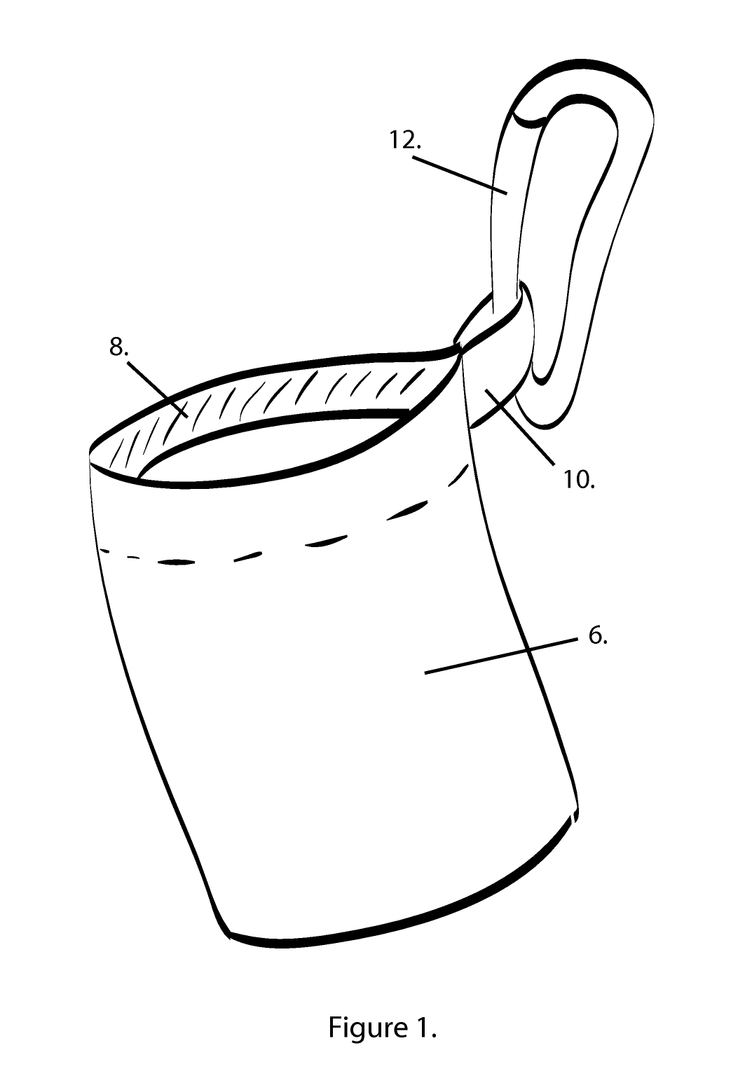

FIG. 1 A refillable bag as an object having mass and webbing combined with a spring snap as means for attachment to a cover.

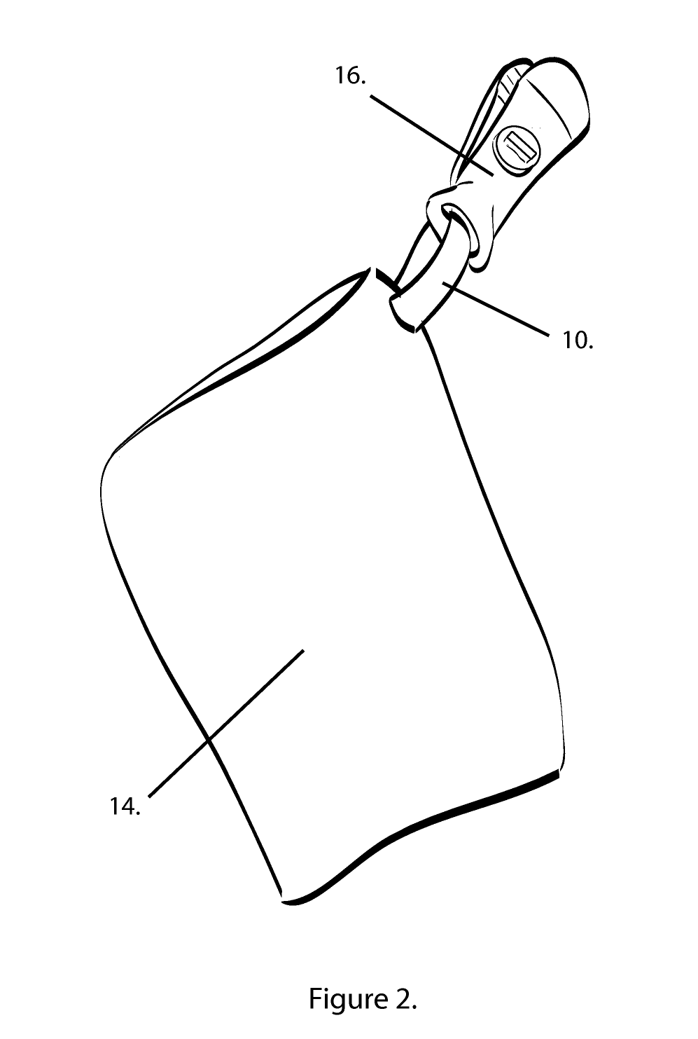

FIG. 2 A sealed bag as an object having mass and webbing combined with an adjustable clamp as means for attachment.

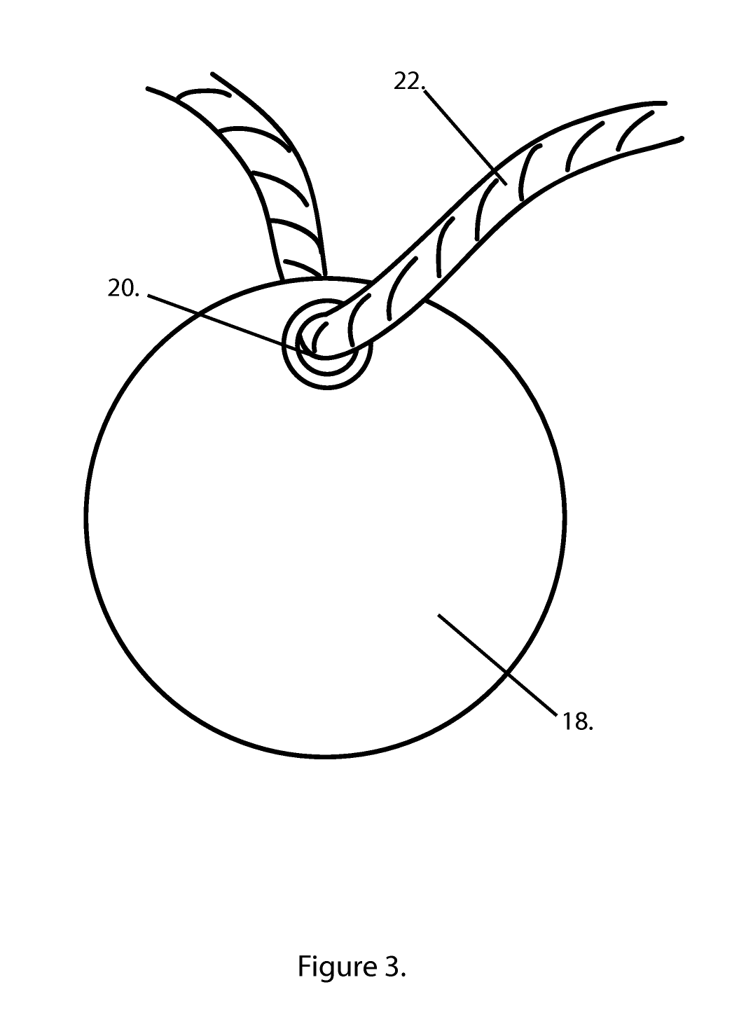

FIG. 3 A solid composition of matter as an object having mass and a molded hole in the mass with a rope as means for attachment.

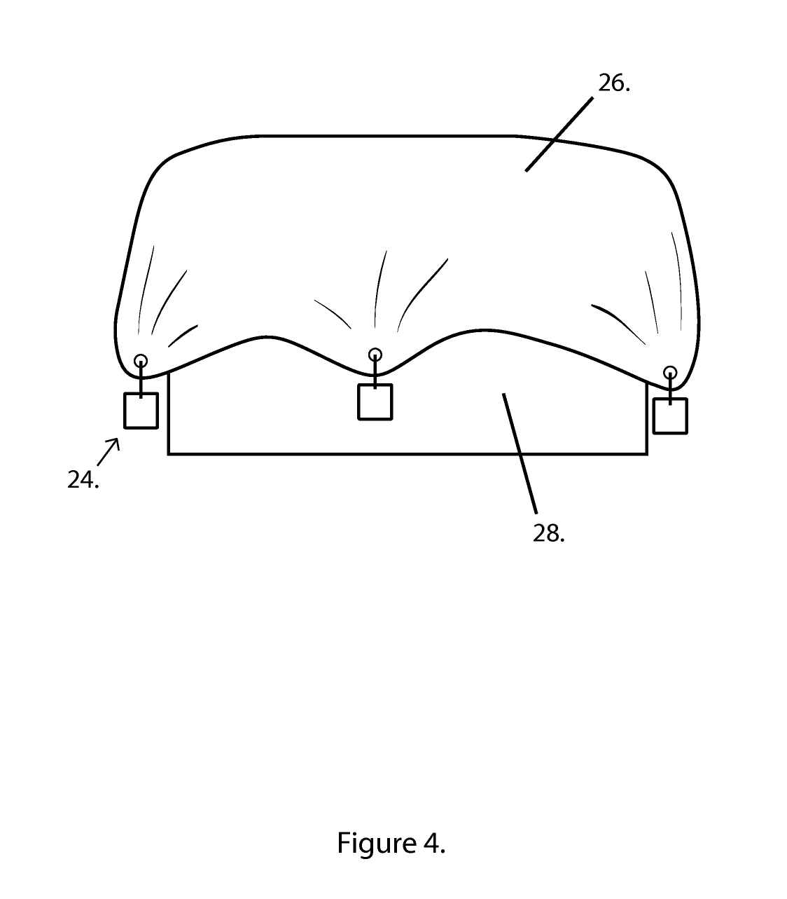

FIG. 4 A cover on equipment with a plurality of weights evenly spread around the cover.

### DESCRIPTION OF THE PREFERRED EMBODIMENTS

Referring now specifically to the drawings, a single weight assembly is illustrated in three different embodiments; FIG. 1, FIG. 2 and FIG. 3. These embodiments and other embodiments that will become apparent are shown generally as reference numeral 24.

FIG. 1 is the preferred embodiment. It illustrates a weight assembly comprising: A refillable bag 6 made of material that is durable for use in outdoor and indoor settings which, when filled with weighted matter, is an object having mass. The refillable bag 6 incorporates a hook and loop type opening 8 that can be sealed at the discretion of the user. Both edges of a strip of webbing material are sewn into the seam of the bag creating a webbing loop 10. In combination with a carabiner type spring snap 12 the webbing loop 10 and the carabiner type spring snap 12 create a way to attach the refillable bag 6 to a cover 26.

The embodiment shown in FIG. 1 has many advantages. An object having mass that can be emptied is easier to transport because its size and weight can be reduced. It allows the user to empty the weight while transporting it from point to point taking up less space in a vehicle. An empty container is less of a weight burden on the user if it is being carried, such as if the user where a backpacker on a camping trip. The user can fill the bag with different amounts and types of matter varying the amount of weight to meet the needs of the user's particular application. The means for attachment in FIG. 1 provide for a strong bond between the object having mass, in this case the refillable bag 6, and the cover 26 when the carabiner type spring snap 12 is applied at a grommet location on the cover 26. The production costs of an empty container are less, reducing costs to the consumer.

FIG. 2 is a weight assembly comprising: A permanently sealed bag 14 made of material that is durable for outdoor and indoor use that is filled with matter creating an object having mass. In combination with an adjustable clamp 16, the webbing loop 10 and the adjustable clamp 16 create a way to attach the sealed bag 14, to the cover 26.

The embodiment shown in FIG. 2 has many advantages. Having a bag that is already filled reduces the workload of the user by eliminating the need for the user to find matter and fill the bag themselves. The adjustable clamp 16 in combination with the webbing loop 10 as a way to attach the weight assembly, allows the weight assembly to attach anywhere along the edge of the cover and allows use of the weight assembly on covers that do not have grommets.

FIG. 3 is a weight assembly comprising: A solid composition of mass 18 creating an object having mass. The solid composition of mass 18 contains a pre-molded hole 20. The pre-molded hole 20 and a rope 22 create a way to attach the solid composition of mass 18 to the cover 26.

The main advantage of a solid composition of mass 18 as an object having mass is the durability of the composition of mass 18 over fabrics forming containers to hold weighted matter.

FIG. 4 shows the embodiments in use. The cover 26 is held in place over a piece of equipment 28 by attaching a plurality of weight assemblies 24, evenly spread, around the cover 26.

### Conclusion Ramifications and Scope

A weight assembly for covers is described above. Various details of the weight assembly may be changed without departing from its scope. For example; the refillable bag 6 can incorporate the webbing loop 10 and the adjustable clamp 16 as a way to attach the weight assembly or, a bendable wire can be used in place of the rope 22 or, an unknown source for an object having mass or combination of materials to attach the assembly to the cover may become apparent and used for this weight assembly. Different shapes and dimensions can also be used to create the weight assembly. Furthermore, the foregoing descriptions of the embodiments are provided for the purpose of illustration only and not for the purpose of limitation. The weight assembly for covers is defined by the claims.

Accordingly the reader will see that the weight assembly of the various embodiments will hold a cover in place when used with a plurality of weight assemblies of the same type.

1. We claim a weight assembly for holding a cover in place whereby, when used with a plurality of weight assemblies of the same type spread evenly around the edges of a cover will hold the cover in position solely by gravity, said weight assembly comprising:
A. an object having mass;
B. means for attaching said object having mass to said cover

2. A weight assembly according to claim 1, wherein said object having mass is a refillable container that allows material with mass to be added to it.

3. A weight assembly according to claim 1, wherein said object having mass is a container, in which a predetermined amount of material with mass has been permanently sealed in the container.

4. A weight assembly according to claim 1, wherein said object having mass is a solid composition of matter of a predetermined mass.

5. A weight assembly according to claim 1, wherein said means for attaching said object having mass to said cover is an assembly of articles which permanently affix said object having mass to said cover.

6. A weight assembly according to claim 1, wherein said means for attaching said object having mass to said cover is an assembly which allows said object having mass to attach and detach from the cover.
